(19) United States
(12) Patent Application Publication
(10) Pub. No.: US 2016/0178580 A1
(43) Pub. Date: Jun. 23, 2016

(54) METHOD AND APPARATUS FOR QUANTIFYING PIPELINE DEFECT BASED ON MAGNETIC FLUX LEAKAGE TESTING

(71) Applicant: Tsinghua University, Beijing (CN)

(72) Inventors: SONGLING HUANG, Beijing (CN); SHEN WANG, Beijing (CN); WEI ZHAO, Beijing (CN); SHISONG LI, Beijing (CN); XINJIE YU, Beijing (CN)

(21) Appl. No.: 14/975,568

(22) Filed: Dec. 18, 2015

(30) Foreign Application Priority Data
Dec. 19, 2014 (CN) 201410799732.1

(51) Int. Cl. G01N 27/83

(52) U.S. Cl. CPC G01N 27/83

(57) ABSTRACT

A method and apparatus for quantifying a pipeline defect based on a magnetic flux leakage testing are provided. The method includes: performing a magnetic flux leakage testing on a pipeline to be tested so as to obtain three-dimensional magnetic flux leakage testing data of the pipeline to be tested; and quantifying a defect on the pipeline to be tested according to the three-dimensional magnetic flux leakage testing data of the pipeline to be tested and a pre-established quantization formula, so as to obtain a size and distribution of the defect.

### CROSS-REFERENCE TO RELATED APPLICATIONS

This application claims priority to and benefits of Chinese Patent Application No. 201410799732.1, filed with the State Intellectual Property Office of P. R. China on Dec. 19, 2014, the entire contents of which are incorporated herein by reference.

### TECHNICAL FIELD

The present invention generally relates to a nondestructive testing technology, and more particularly, to a method and an apparatus for quantifying a defect based on a magnetic flux leakage testing.

### BACKGROUND

A magnetic flux leakage (MFL) testing is a common nondestructive testing method, which has unparalleled advantages in aspects of quality testing and security monitoring of ferromagnetic material. However, since there are complex nonlinear relationships between magnetic flux leakage testing signals and the size of defect, it becomes a technical difficulty to identify features of the defect and quantify the defect by analyzing the magnetic flux leakage testing signals. In addition, in conventional defect quantization methods, the features of the magnetic flux leakage testing signals are from a single source and with a low distinguishing degree, such that the recognition capability of the defect and the accuracy of quantifying the defect are decreased.

### SUMMARY

The present disclosure provides a method for quantifying a pipeline defect based on a magnetic flux leakage testing, including: performing a magnetic flux leakage testing on a pipeline to be tested so as to obtain three-dimensional magnetic flux leakage testing data of the pipeline to be tested; and quantifying a defect on the pipeline to be tested according to the three-dimensional magnetic flux leakage testing data of the pipeline to be tested and a pre-established quantization formula, so as to obtain a size and distribution of the defect; in which the three-dimensional magnetic flux leakage testing data comprises: circumferential magnetic flux leakage testing data, axial magnetic flux leakage testing data and radial magnetic flux leakage testing data.

A method for quantifying a pipeline defect based on a magnetic flux leakage testing provided in embodiments of the present disclosure includes: S1: forming three groups of standard defects on a reference pipeline with a same material and thickness as a pipeline to be tested, in which the three groups of standard defects are equally spaced in a circumferential direction, and standard defects in each group are equally spaced in an axial direction; S2: saturation magnetizing the reference pipeline by a direct current magnetic field and collecting data at a first equal interval in the reference pipeline by a three-dimensional sensor array at a preset speed so as to obtain three-dimensional magnetic flux leakage testing data of the reference pipeline, in which a liftoff value of each three-dimensional sensor is within a preset value range; S3: obtaining an average of the of the three-dimensional magnetic flux leakage testing data of the reference pipeline and filtering the three-dimensional magnetic flux leakage testing data of the reference pipeline with a threshold preset multiple of the average so as to obtain features of a magnetic flux leakage signal of the reference pipeline, in which the features of the magnetic flux leakage signal include features of features of a circumferential magnetic flux leakage signal, features of an axial magnetic flux leakage signal and features of a radial magnetic flux leakage signal; S4: evaluating the standard defects according to the features of the circumferential magnetic flux leakage signal of the reference pipeline to obtain a width quantification formula; S5: evaluating the standard defects according to the features of the radial magnetic flux leakage signal of the reference pipeline to obtain a length quantification formula; S6: evaluating the standard defects according to the features of the axial magnetic flux leakage signal of the reference pipeline and the features of the radial magnetic flux leakage signal of the reference pipeline to obtain a depth quantification formula; S7: obtaining three-dimensional magnetic flux leakage testing data of the pipeline to be tested, extracting features of magnetic flux leakage signal of the pipeline to be tested, and substituting the features of the magnetic flux leakage signal of the pipeline to be tested into the width quantization formula, the length quantification formula and the depth quantification formula respectively, so as to obtain a size and distribution of the defect on the pipeline to be tested.

In some embodiments, a first group comprises N variable-length defects, in which a width of each of the N variable-length defects is 2.5 T, a depth of each of the N variable-length defects is 0.25 T, and lengths of the N variable-length defects are in an array of 0.5 T, 1 T, . . . , N×0.5 T; a second group comprises N variable-width defects, in which a length of each of the N variable-width defects is 2.5 T, a depth of each of the N variable-width defects is 0.25 T, and widths of the N variable-width defects are in the array of 0.5 T, 1 T, N×0.5 T; a third group comprises N variable-depth defects, in which a length of each of the N variable-depth defects is 2.5 T, a width of each of the N variable-depth defects is 0.5 T, and depths of the N variable-depth defects are in the array of 0.05 T, 0.1 T, . . . , N×0.05 T, wherein difference between each two adjacent element in the array is 0.5 T, N is a positive integer, T represents the thickness of the reference pipeline and a space between each two standard defects in each group is within a range of 10 T˜30 T.

In some embodiments, evaluating the standard defects according to features of a circumferential magnetic flux leakage signal of the reference pipeline so as to obtain a width quantification formula includes: measuring and extracting a number of influenced channels according to the circumferential magnetic flux leakage signal for a standard defect, and analyzing a relationship between the number of influenced channels and a width of the standard defect, so as to obtain the width quantization formula, in which the width quantization formula is expressed by a formula of

W=R×π×N₁/N₀,

where W represents the width of the standard defect, R represents an external diameter of the reference pipeline, N₁ represents the number of influenced channels and N₀ represents a number of all channels in the circumferential direction.

In some embodiments, evaluating the standard defects according to features of a radial magnetic flux leakage signal of the reference pipeline so as to obtain a length quantification formula includes: measuring and extracting a peak-valley space of the radial magnetic flux leakage signal for a standard defect, analyzing a relationship between the peak-valley space and a length of the standard defect, so as to obtain the length quantization formula based on a linear regression calculation, in which the length quantization formula is expressed by a formula of

L=a×Sₚ₋ᵥ+b

where L represents the length of the standard defect, Sₚ₋ᵥ represents the peak-valley space, a and b are preset coefficients.

In some embodiments, evaluating the standard defects according to features of an axial magnetic flux leakage signal of the reference pipeline and the features of the radial magnetic flux leakage signal of the reference pipeline so as to obtain a depth quantification formula includes: measuring and extracting a peak value of the axial magnetic flux leakage signal and a peak-valley value of the radial magnetic flux leakage signal for a standard defect, analyzing a relationship between the peak value, the peak-valley value and a depth of the standard defect, so as to obtain the depth quantization formula based on a multivariate linear fitting and introduced speed factors, in which the depth quantization formula is expressed by a formula of

$$D = \sqrt{\frac{L}{W}} \times ( \sqrt[3]{e \times {X}_{p}^{2}} \times {σ}_{1} + f \times {Y}_{p - v} \times {σ}_{2} ) - g$$

where D represents the depth of the standard defect, L represents a length of the standard defect, W represents a width of the standard defect, Xₚ represents the peak value of the axial magnetic flux leakage signal, Yₚ₋ᵥ represents the peak-valley value of the radial magnetic flux leakage signal, σ₁ represents a speed factor of the peak value in the axial direction, σ₂ represents a speed factor of the peak-valley value in the radial direction, σ₁=j+kV, σ₂=m+nV, in which e, f, g, j, k, m, n are preset coefficients.

In some embodiments, the preset speed is within a range of 0.1˜3.0 m/s, the preset value range is [1.0 mm, 5.0 mm] and the first equal interval is within a range of 0.5˜8.0 mm.

In some embodiments, the features of circumferential magnetic flux leakage signal comprise a number N₁ of channels influenced by the circumferential magnetic flux leakage signal, a number N₀ of all channels in the circumferential direction; the features of radial magnetic flux leakage signal comprise a peak-valley space Sₚ₋ᵥ of the radial magnetic flux leakage signal, and a peak-valley value Yₚ₋ᵥ of the radial magnetic flux leakage signal; and the features of axial magnetic flux leakage signal comprise a peak value Xₚ of the axial magnetic flux leakage signal.

With the method for quantifying a pipeline defect based on a magnetic flux leakage testing according to embodiments of the present disclosure, the pipeline to be tested is scanned by the three-dimensional sensor array to collect the circumferential magnetic flux leakage signal, the axial magnetic flux leakage signal and the radial magnetic flux leakage signal, and then the length quantization formula, the width quantization formula and the depth quantization formula are determined, such that the size and distribution of the defect of the pipeline to be tested may be determined according to the circumferential magnetic flux leakage signal, the axial magnetic flux leakage signal and the radial magnetic flux leakage signal, the length quantization formula, the width quantization formula and the depth quantization formula. By combining features of the circumferential magnetic flux leakage signal, the axial magnetic flux leakage signal and the radial magnetic flux leakage signal, the distinguishing degree of the defect and the accuracy are improved, also it is easy to implement the method manually or by a computer, thus overcoming disadvantages of the conventional quantization algorithm which evaluates the defect only using the axial magnetic flux leakage signal, improving recognition capability and the quantification accuracy for all kinds of irregular defects and having a broad application prospect.

Additional aspects and advantages of embodiments of present invention will be given in part in the following descriptions, become apparent in part from the following descriptions, or be learned from the practice of the embodiments of the present invention.

### BRIEF DESCRIPTION OF THE DRAWINGS

These and other aspects and advantages of embodiments of the present invention will become apparent and more readily appreciated from the following descriptions made with reference to the accompanying drawings, in which:

FIG. 1 is a flow chart of a method for quantifying a pipeline defect based on a magnetic flux leakage testing according to an embodiment of the present disclosure;

FIG. 2 is a flow chart of a method for establishing a pre-established quantization formula according to an embodiment of the present disclosure;

FIG. 3 is a schematic diagram showing a wave of amplitudes of circumferential magnetic flux leakage signal according to an embodiment of the present disclosure;

FIG. 4 is a schematic diagram showing features of a wave of radial magnetic flux leakage signal according to an embodiment of the present disclosure; and

FIG. 5 is a flow chart of a method for obtaining preset quantization formulas according to an exemplary embodiment of the present disclosure.

### DETAILED DESCRIPTION

Reference will be made in detail to embodiments of the present disclosure. Embodiments of the present disclosure will be shown in drawings, in which the same or similar elements and the elements having same or similar functions are denoted by like reference numerals throughout the descriptions. The embodiments described herein according to drawings are explanatory and illustrative, not construed to limit the present disclosure.

In addition, terms such as “first” and “second” are used herein for purposes of description and are not intended to indicate or imply relative importance or significance. Thus, the feature defined with “first” and “second” may comprise one or more this feature. In the description of the present disclosure, “a plurality of” means two or more than two, unless specified otherwise.

In the description of the present disclosure, unless specified or limited otherwise, the terms “mounted,” “connected,” and “coupled” and variations thereof are used broadly and encompass such as mechanical or electrical mountings, connections and couplings, also can be inner mountings, connections and couplings of two components, and further can be direct and indirect mountings, connections, and couplings, which can be understood by those skilled in the art according to the detail embodiment of the present disclosure.

In the description of the present disclosure, unless specified or limited otherwise, a structure in which a first feature is “on” a second feature may include an embodiment in which the first feature directly contacts the second feature, and may also include an embodiment in which an additional feature is formed between the first feature and the second feature so that the first feature does not directly contact the second feature, unless specified otherwise. Furthermore, a first feature “on,” “above,” or “on top of” a second feature may include an embodiment in which the first feature is right “on,” “above,” or “on top of” the second feature, and may also include an embodiment in which the first feature is not right “on,” “above,” or “on top of” the second feature, or just means that the first feature is at a height higher than that of the second feature.

A method for quantifying a pipeline defect based on a magnetic flux leakage testing according to embodiments of the present disclosure will be described with reference to accompanying drawings.

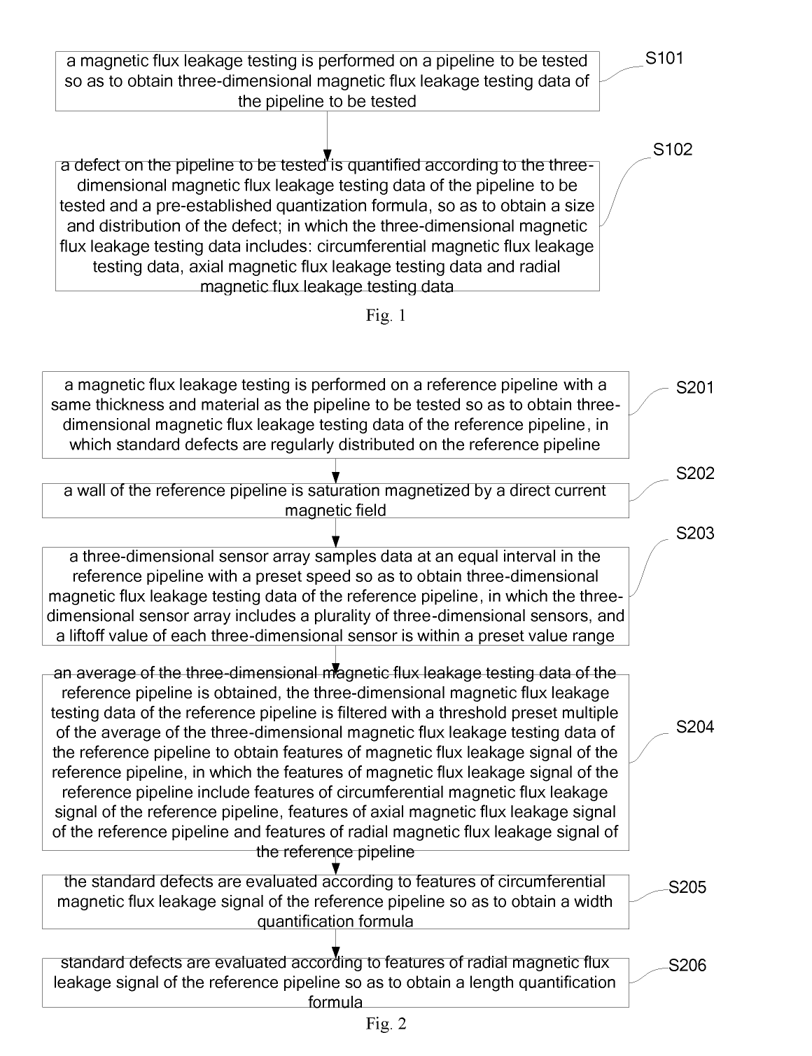

FIG. 1 is a block diagram of a method for quantifying a pipeline defect based on a magnetic flux leakage testing according to an embodiment of the present disclosure. Referring to FIG. 1, the method includes following steps.

In step S101, a magnetic flux leakage testing is performed on a pipeline to be tested so as to obtain three-dimensional magnetic flux leakage testing data of the pipeline to be tested.

In step S102, a defect on the pipeline to be tested is quantified according to the three-dimensional magnetic flux leakage testing data of the pipeline to be tested and a pre-established quantization formula, so as to obtain a size and distribution of the defect; in which the three-dimensional magnetic flux leakage testing data includes: circumferential magnetic flux leakage testing data, axial magnetic flux leakage testing data and radial magnetic flux leakage testing data.

The pre-established quantization formula may be established by steps as shown in FIG. 2.

In step S201, a magnetic flux leakage testing is performed on a reference pipeline with a same thickness and material as the pipeline to be tested so as to obtain three-dimensional magnetic flux leakage testing data of the reference pipeline, in which standard defects are regularly distributed on the reference pipeline.

Specifically, standard defects are formed on a reference pipeline with the same material and thickness as the pipeline to be tested. There may be three groups of standard defects formed on the reference pipeline. The three groups of standard defects are equally spaced in a circumferential direction; each group includes N standard defects distributed at an equal interval in an axial direction of the reference pipeline, in which N is a positive integer.

In an embodiment of the present disclosure, a first group includes N variable-length defects, in which a width of each of the N variable-length defects is 2.5 T, a depth of each of the N variable-length defects is 0.25 T, lengths of the N variable-length defects are in an array of 0.5 T, 1 T, . . . , N×0.5 T; a second group includes N variable-width defects, in which a length of each of the N variable-width defects is 2.5 T, a depth of each of the N variable-width defects is 0.25 T, widths of the N variable-width defects are in an array of 0.5 T, 1 T, . . . , N×0.5 T; a third group includes N variable-depth defects, in which a length of each of the N variable-depth defects is 2.5 T, a width of each of the N variable-depth defects is 0.5 T, depths of the N variable-depth defects are in an array of 0.05 T, 0.1 T, . . . , N×0.05 T, in which difference between each two adjacent element in the array is 0.5 T, T represents the thickness of the reference pipeline and the space between each two standard defects in the axial direction is within a range of 10 T˜30 T. N is set without exceeding a size requirement of the reference pipeline, for example, N is set reasonably according to the experimental requirement and a criterion of not exceeding the size requirement of the reference pipeline. Boundaries of the standard defects are transited naturally in arc. The thickness of the reference pipeline may be within a range of 7.0˜36.0 mm.

In step S202, a wall of the reference pipeline is saturation magnetized by a direct current magnetic field.

In step S203, a three-dimensional sensor array samples data at an equal interval in the reference pipeline with a preset speed so as to obtain three-dimensional magnetic flux leakage testing data of the reference pipeline, in which the three-dimensional sensor array includes a plurality of three-dimensional sensors, and a liftoff value of each three-dimensional sensor is within a preset value range. The three-dimensional magnetic flux leakage testing data of the reference pipeline includes circumferential magnetic flux leakage testing data of the reference pipeline, axial magnetic flux leakage testing data of the reference pipeline and radial magnetic flux leakage testing data of the reference pipeline.

In an embodiment, the three-dimensional sensor array includes a plurality of sensors disposed in a circumferential direction of the reference pipeline. The three-dimensional sensor array moves in the reference pipeline along an axial direction of the reference pipeline at a preset speed to obtain three-dimensional magnetic flux leakage testing data of the reference pipeline.

In an embodiment of the present disclosure, the preset speed is within a range of 0.1˜3.0 m/s and the data is sampled at the equal interval within a range of 0.5˜8.0 mm.

Further, in an embodiment of the present disclosure, the liftoff value of each three-dimensional sensor is within the preset value range of [1.0 mm, 5.0 mm].

Specifically, in an embodiment of the present disclosure, the wall of a pipeline may be saturation magnetized by the direct current magnetic field, the three-dimensional sensor array collects data at the equal interval in the pipeline with the certain running speed, and the liftoff value of each sensor in the three-dimensional sensor array is maintained within the preset value range of [1.0 mm, 5.0 mm]. The sensor may be a Hall sensor, and the liftoff value of the sensor is a distance from the Hall sensor to a surface of an inner wall of the pipeline.

In step 204, an average of the three-dimensional magnetic flux leakage testing data of the reference pipeline is obtained, the three-dimensional magnetic flux leakage testing data of the reference pipeline is filtered with a threshold preset multiple of the average of the three-dimensional magnetic flux leakage testing data of the reference pipeline to obtain features of magnetic flux leakage signal of the reference pipeline, in which the features of magnetic flux leakage signal of the reference pipeline include features of circumferential magnetic flux leakage signal of the reference pipeline, features of axial magnetic flux leakage signal of the reference pipeline and features of radial magnetic flux leakage signal of the reference pipeline.

In an embodiment of the present disclosure, the preset multiple is within a range of [1.2, 1.5]. In embodiments of the present disclosure, the three-dimensional magnetic flux leakage testing data of the reference pipeline obtained in step S203 is calculated to obtain the average, and the average is multiplied by a value in a range of 1.2˜1.5 to obtain the threshold for filtering the three-dimensional magnetic flux leakage testing data of the reference pipeline, such that some obvious erroneous data and abnormal data may be excluded.

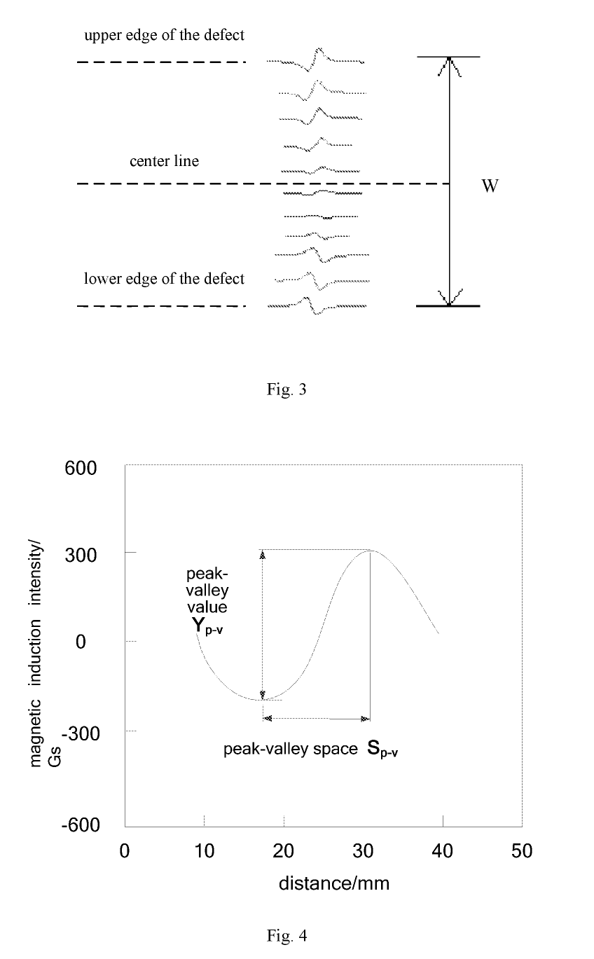

In step S205, the standard defects are evaluated according to features of circumferential magnetic flux leakage signal of the reference pipeline so as to obtain a width quantification formula. FIG. 3 is a schematic diagram showing a wave of amplitudes of a circumferential magnetic flux leakage signal according to an embodiment of the present disclosure. In an embodiment of the present disclosure, referring to FIG. 3, in the defect area, the defect width information is significantly expressed by the circumferential magnetic flux leakage signal. Specifically, above a center line of defect, the amplitude transition of the circumferential magnetic flux leakage signal is converted from a peak to a valley. Below the center line of defect, the amplitude transition is converted from a valley to a peak. At positions where the strongest amplitudes locate, the edges (i.e. the edges in the width direction) of defect may be defined, the signals above and below the center line are symmetric about the center line, i.e., each pair of symmetrical signal has the same amplitude and opposite trend. So step S205 may be implemented by following way.

For each standard defect, the number of influenced channels is measured according to the circumferential magnetic flux leakage signal, and then the relationship between the number of influenced channels and the width of the standard defect is analyzed, such that the width quantization formula may be obtained, in which the width quantization formula is expressed by a formula of

W=R×π×N₁/N₀,

where W represents the width of a standard defect, R represents an external diameter of the reference pipeline, each of W and R adopts mm as the unit, N₁ represents the number of influenced channels and N₀ represents the number of all channels in the circumferential direction, i.e. the number of Hall sensors in the circumferential direction. For the pipeline to be tested, since R and N₀ are known, using the above formula, the defect width of a defect on this pipeline to be tested may be calculated, after the number of influenced channels N₁ with regard to the defect is measured.

In step S206, standard defects are evaluated according to features of radial magnetic flux leakage signal of the reference pipeline so as to obtain a length quantification formula.

FIG. 4 is a schematic diagram showing features of a wave of a radial magnetic flux leakage signal according to an embodiment of the present disclosure. In an embodiment of the present disclosure, referring to FIG. 4, in the defect area, the radial magnetic flux leakage signal changes suddenly, such that the peak and the valley are formed, and at positions where the radial magnetic flux leakage signal changes suddenly, the edges (i.e. the edges in the length direction) of defect may be defined, which are less relevant to the defect width and the defect depth. So step S206 may be implemented by following way.

For each standard defect, a peak-valley space of the radial magnetic flux leakage signal is measured, and a relationship between the peak-valley space and the length of the standard defect is analyzed, such that the length quantization formula may be obtained based on a linear regression calculation, in which the length quantization formula is expressed by a formula of

L=a×Sₚ₋ᵥ+b

where L represents the length of a standard defect, Sₚ₋ᵥ represents the peak-valley space, and the peak-valley space indicates a distance from a peak of the radial magnetic flux leakage signal to a valley of the radial magnetic flux leakage signal, each of L and Sₚ₋ᵥ adopts mm as the unit, a and b are preset coefficients. For the pipeline to be tested, using the above formula, the defect length of a defect on this pipeline to be tested may be calculated, after the peak-valley space Sₚ₋ᵥ of the radial magnetic flux leakage signal with regard to the defect is measured.

In step S207, standard defects are evaluated according to the features of axial magnetic flux leakage signal and features of radial magnetic flux leakage signal of the reference pipeline so as to obtain a depth quantification formula.

In an embodiment of the present disclosure, different from the defect width and the defect length, the defect depth is influenced by many factors, such as pipeline material, wall thickness, testing speed, particularly, is directly related to an opening shape of the defect, i.e. the defect depth is influenced by the defect length and the defect width simultaneously. So step S207 may be implemented by following way.

For each standard defect, a peak value of the axial magnetic flux leakage signal and a peak-valley value of the radial magnetic flux leakage signal are measured, and a relationship between the peak value, the peak-valley value and a depth of the standard defect is analyzed, such that the depth quantization formula may be obtained based on a multivariate linear fitting and introduced speed factors, in which the depth quantization formula is expressed by a formula of

$$D = \sqrt{\frac{L}{W}} \times ( \sqrt[3]{e \times {X}_{p}^{2}} \times {σ}_{1} + f \times {Y}_{p - v} \times {σ}_{2} ) - g$$

where D represents the depth of a standard defect and adopts mm as the unit, L represents a length of the standard defect, W represents a width of the standard defect, Xₚ represents the peak value, Yₚ₋ᵥ represents the peak-valley value, and the peak-valley value indicates a difference between a peak value of the radial magnetic flux leakage signal and a valley value of the radial magnetic flux leakage signal, each of Xₚ and Yₚ₋ᵥ adopts Gs as the unit, σ₁ represents a speed factor of the peak value in the axial direction, σ₂ represents a speed factor of the peak-valley value in the radial direction, σ₁=j+kV, σ₂=m+nV, in which e, f, g, j, k, m, n are preset coefficients and undetermined coefficients. For the pipeline to be tested, using the above formula, the defect depth of a defect on this pipeline to be tested may be calculated, after the peak value Xₚ of the axial magnetic flux leakage signal and the peak-valley value Yₚ₋ᵥ of the radial magnetic flux leakage signal with regard to the defect are measured, and the defect width and the defect length of this defect are calculated.

After obtaining the pre-established quantization formula, the defect on the pipeline to be tested may be quantified according to the three-dimensional magnetic flux leakage testing data of the pipeline to be tested and the pre-established quantization formula by following steps.

Firstly, an average of the three-dimensional magnetic flux leakage testing data of the pipeline to be tested is obtained.

The method of obtaining three-dimensional magnetic flux leakage testing data of the pipeline to be tested is similar to that of obtaining the three-dimensional magnetic flux leakage testing data of the reference pipeline. Specifically, the three-dimensional magnetic flux leakage testing data of the pipeline to be tested may be obtained by steps of: saturation magnetizing the pipeline to be tested by a direct current magnetic field and collecting data at an equal interval in the pipeline to be tested by a three-dimensional sensor array with a preset speed so as to obtain the three-dimensional magnetic flux leakage testing data of the pipeline to be tested. The three-dimensional magnetic flux leakage testing data of the pipeline to be tested includes circumferential magnetic flux leakage testing data of the pipeline to be tested, axial magnetic flux leakage testing data of the pipeline to be tested and radial magnetic flux leakage testing data of the pipeline to be tested.

Specifically, in an embodiment of the present disclosure, the pipeline to be tested is saturation magnetized by a direct current magnetic field with a same intensity as the direct current magnetic field for saturation magnetizing the reference pipeline. The pipeline to be tested may be scanned by a three-dimensional sensor array with a preset speed the same as the preset speed of the three-dimensional sensor used for scanning the reference pipeline, and the data is collected at the same interval in the pipeline to be tested and the reference pipeline by the three-dimensional sensor array. Also, the liftoff value of each sensor of the three-dimensional sensor used for scanning the pipeline to be tested is the same as that of each sensor of the three-dimensional sensor used for scanning the reference pipeline.

Secondly, the three-dimensional magnetic flux leakage testing data of the pipeline to be tested is filtered with a threshold preset multiple of the average of the three-dimensional magnetic flux leakage testing data of the pipeline to be tested, so as to obtain features of magnetic flux leakage signal of the pipeline to be tested.

The features of magnetic flux leakage signal of the pipeline to be tested include features of circumferential magnetic flux leakage signal of the pipeline to be tested, features of axial magnetic flux leakage signal of the pipeline to be tested and features of radial magnetic flux leakage signal of the pipeline to be tested. The features of circumferential magnetic flux leakage signal include a number N₁ of channels influenced by the circumferential magnetic flux leakage signal, a number N₀ of all channels in the circumferential direction; the features of radial magnetic flux leakage signal include a peak-valley space Sₚ₋ᵥ of the radial magnetic flux leakage signal, and a peak-valley value Yₚ₋ᵥ of the radial magnetic flux leakage signal; and the features of axial magnetic flux leakage signal include a peak value Xₚ of the axial magnetic flux leakage signal.

Thirdly, the features of the magnetic flux leakage signal of the pipeline to be tested are substituted into the pre-established quantization formula, so as to obtain a size and distribution of the defect.

With the method for quantifying a defect based on a magnetic flux leakage testing according to embodiments of the present disclosure, the pipeline to be tested is scanned by the three-dimensional sensor array to collect the circumferential magnetic flux leakage signal, the axial magnetic flux leakage signal and the radial magnetic flux leakage signal, and then the length quantization formula, the width quantization formula and the depth quantization formula are determined, such that the size and distribution of the defect of the pipeline to be tested may be determined according to the circumferential magnetic flux leakage signal, the axial magnetic flux leakage signal and the radial magnetic flux leakage signal, the length quantization formula, the width quantization formula and the depth quantization formula. By combining features of the circumferential magnetic flux leakage signal, the axial magnetic flux leakage signal and the radial magnetic flux leakage signal, the distinguishing degree of the defect and the accuracy are improved, also it is easy to implement the method manually or by a computer, thus overcoming disadvantages of the conventional quantization algorithm which evaluates the defect only using the axial magnetic flux leakage signal, improving recognition capability and the quantification accuracy for all kinds of irregular defects and having a broad application prospect.

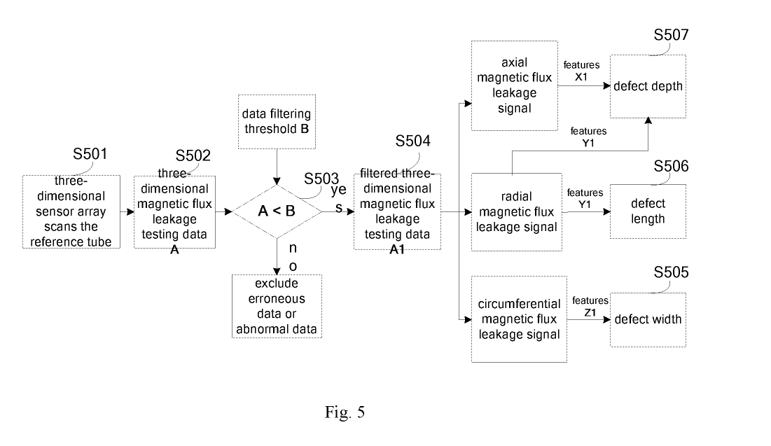

FIG. 5 is a flow chart of a method for obtaining preset quantization formulas according to an exemplary embodiment of the present disclosure. Referring to FIG. 5, in this embodiment, the caliber of the oil-gas pipeline to be tested is 273 mm, and the wall thickness of the oil-gas pipeline to be tested is 12 mm. The three-dimensional sensor array has 240 probe modules distributed at an equal space along the circumferential direction, and each probe module includes three Hall probes, in which directions of the three Hall probes are circumferential direction, axial direction and radial direction respectively. Therefore there are 720 hall probes totally.

In step S501, a reference pipeline is scanned by the three-dimensional sensor array.

Specifically, the reference pipeline is tested firstly. The reference pipeline has a same wall thickness and material as the oil-gas pipeline to be tested. And three groups of standard defects may be equally spaced on the reference pipeline in a circumferential direction of the reference pipeline. Standard defects in each group are equally spaced in an axial direction of the reference pipeline. In this embodiment, each group includes sixteen standard defects.

Specifically, a first group includes 16 variable-length defects, in which a width of each of the 16 variable-length defects is 30 mm, a depth of each of the 16 variable-length defects is 3 mm, lengths of the 16 variable-length defects are in an array of 6 mm, 12 mm, . . . , 96 mm; a second group includes 16 variable-width defects, in which a length of each of the 16 variable-width defects is 30 mm, a depth of each of the 16 variable-width defects is 3 mm, widths of the 16 variable-width defects are in the array of 6 mm, 12 mm, . . . , 96 mm; a third group includes 16 variable-depth defects, in which a length of each of the 16 variable-depth defects is 30 mm, a width of each of the 16 variable-depth defects is 30 mm, depths of the 16 variable-width defects are in the array of 0.6 mm, 1.2 mm, . . . , 9.6 mm. All of 48 standard defects are disposed without exceeding the size requirement of the reference pipeline, and boundaries of the standard defects are transited naturally in arc. Space between each two standard defects in each group is 180 mm.

In step S502, the three-dimensional magnetic flux leakage testing data A of the reference pipeline is obtained.

Specifically, the wall of the reference pipeline is saturation magnetized by a direct current magnetic field. Then the three-dimensional sensor array collects data at an equal interval within the reference pipeline with a speed of 0.4 m/s, in which the liftoff value of each sensor is maintained at 2.5 mm, such that the circumferential magnetic flux leakage testing data, the axial magnetic flux leakage testing data and the radial magnetic flux leakage testing data of the standard defects within the reference pipeline may be obtained. The data is collected at the interval of 3.57 mm both in the axial direction and the circumferential direction.

In step S503, it is determined whether the three-dimensional magnetic flux leakage testing data A of the reference pipeline is less than a data filtering threshold B to exclude erroneous data or abnormal data.

For example, an average of all the discrete three-dimensional magnetic flux leakage testing data obtained in step S502 is calculated, and a value obtained by multiplying the average by 1.25 is used as the data filtering threshold to filter the three-dimensional magnetic flux leakage testing data to exclude some obvious erroneous data or abnormal data.

In step S504, filtered three-dimensional magnetic flux leakage testing data A1 of the reference pipeline is obtained.

In step S505, the standard defects are evaluated according to features Z1 of a circumferential magnetic flux leakage signal, so as to obtain the width quantification formula to calculate the defect width.

Specifically, in this embodiment according to the present disclosure, the width quantification formula is obtained by evaluating the standard defects according to the features of the circumferential magnetic flux leakage signal. The circumferential magnetic flux leakage signal is the component of the magnetic flux leakage signal in the circumferential direction. Referring to FIG. 3, above the center line of the defect, the amplitude transition of the circumferential magnetic flux leakage signal is converted from a peak to a valley. Below the center line of the defect, the amplitude transition is converted from a valley to a peak. At positions where the strongest amplitudes locate, the edges (i.e. the edges in the width direction) of defect may be defined, the signals above and below the center line are symmetric about the center line, i.e., each pair of symmetrical signal has the same amplitude and opposite trend.

Specifically, for each of the second group of variable-width defects, the number of influenced channels is measured according to the circumferential magnetic flux leakage signal, and then a relationship between the number of influenced channels and the width of the variable-width defect is analyzed, such that the width quantization formula may be obtained, which is expressed by a formula of

W=1.138×π×N₁

When using this formula to calculate a width of a defect, W represents the width of the defect, and adopts mm as the unit, N₁ represents the number of influenced channels with regard to the defect.

In step S506, the standard defects are evaluated according to features Y1 of a radial magnetic flux leakage signal, so as to obtain the length quantification formula to calculate the defect length.

Specifically, in this embodiment according to the present disclosure, the length quantification formula is obtained by evaluating the standard defects according to the features of the radial magnetic flux leakage signal. The radial magnetic flux leakage signal is the component of the magnetic flux leakage signal in the radial direction. Referring to FIG. 4, in the defect area, the radial magnetic flux leakage signal changes suddenly, such that the peak and the valley are formed, and at positions where the radial magnetic flux leakage signal changes suddenly, the edges (i.e. the edges in the length direction) of defect may be defined.

Specifically, for each of the first group of variable-length defects, the peak-valley space of the radial magnetic flux leakage signal is measured, and then a relationship between the peak-valley space and the length of the variable-length defect is analyzed, such that the length quantization formula may be obtained based on a linear regression calculation, which is expressed by a formula of

L=0.918×Sₚ₋ᵥ+1.156

When using this formula to calculate a length of a defect, L represents the length of the defect, Sₚ₋ᵥ represents the peak-valley space of the radial magnetic flux leakage signal with regard to the defect, and adopts mm as the unit.

In step S507, the standard defects are evaluated according to features X1 of an axial magnetic flux leakage signal and features Y1 of the radial magnetic flux leakage signal, so as to obtain the depth quantification formula to calculate the defect depth.

Specifically, in this embodiment according to the present disclosure, the depth quantification formula is obtained by evaluating the standard defects according to the features of the axial magnetic flux leakage signal and the features of the radial magnetic flux leakage signal. The axial magnetic flux leakage signal is the component of the magnetic flux leakage signal in the axial direction. Different from the defect width and the defect length, the defect depth is influenced by many factors, such as pipeline material, wall thickness, testing speed, particularly, is directly related to an opening shape of the defect, i.e. the defect depth is influenced by the defect length and the defect width simultaneously.

For each of the third group of variable-depth defects, a peak value of the axial magnetic flux leakage signal and a peak-valley value of the radial magnetic flux leakage signal are measured, and a relationship between the peak value, the peak-valley value and a depth of the variable-depth defect is analyzed, such that the depth quantization formula is obtained based on the multivariate linear fitting and introduced speed factors, which is expressed by a formula of

$$D = \sqrt{\frac{L}{W}} \times ( \sqrt[3]{0.0023 \times {X}_{p}^{2}} \times ( 0.681 + 0.260 \times V ) + 0.046 \times {Y}_{p - v} \times ( 0.904 + 0.113 \times V ) ) - 0.219$$

When using this formula to calculate a depth of a defect, D represents the depth of the defect and adopts mm as the unit, L represents a length of the defect, W represents a width of the defect, Xₚ represents the peak value of the axial magnetic flux leakage signal with regard to the defect, Yₚ₋ᵥ represents the peak-valley value of the radial magnetic flux leakage signal with regard to the defect, units of which both are mm Gs, σ₁ represents the speed factor of the peak value in the axial direction, σ₂ represents the speed factor of the peak-valley value in the radial direction, σ₁=0.681+0.260×V, σ₂=0.904+0.113×V.

Finally, the corrosion defect on the oil-gas pipeline to be tested is tested by the three-dimensional sensor array in a testing condition the same as the condition in which the reference pipeline is tested, i.e. the liftoff value of each sensor is 2.5 mm, the data is collected at the interval of 3.57 mm both in the axial direction and the circumferential direction, the running speed of the three-dimensional sensor array is 0.4 m/s and a value obtained by multiplying 1.25 by the average of the three-dimensional magnetic flux leakage testing data of the oil-gas pipeline to be tested is used as the data filtering threshold to exclude some obvious erroneous data or abnormal data. The leakage magnetic field of the corrosion defect may be obtained, in which the number of channels influenced by the circumferential magnetic flux leakage signal is 19, the peak value of the axial magnetic flux leakage signal is 212.6 Gs, the peak-valley value of the radial magnetic flux leakage signal is 82.5 Gs and the peak-valley space of the radial magnetic flux leakage signal is 98 mm. The above features are substituted into the above three quantization formulas to obtain the defect length, the defect width and the defect depth, which are 91.12 mm, 67.92 mm, and 8.27 mm respectively. The actual length, width and depth of the corrosion defect are 95.2 mm, 63 mm, and 8.8 mm respectively. Thus, the quantization error of the length is 4.3%, the quantization error of the width is 7.8% and the quantization error of the depth is 6.0%, each of which is less than 10%. In addition, by verifying the method with other corrosion defects, it may be seen that the method may effectively quantify corrosion defects on various pipelines, and has advantages of accurate calculation and fast speed, and particularly, the method may meet the requirement for quickly processing large magnetic flux leakage testing data.

With the method for quantifying a pipeline defect based on a magnetic flux leakage testing according to embodiments of the present disclosure, the pipeline to be tested is scanned by the three-dimensional sensor array to collect the circumferential magnetic flux leakage signal, the axial magnetic flux leakage signal and the radial magnetic flux leakage signal, and then the length quantization formula, the width quantization formula and the depth quantization formula are determined, such that the size and distribution of the defect of the pipeline to be tested may be determined according to the circumferential magnetic flux leakage signal, the axial magnetic flux leakage signal and the radial magnetic flux leakage signal, the length quantization formula, the width quantization formula and the depth quantization formula. By combining features of the circumferential magnetic flux leakage signal, the axial magnetic flux leakage signal and the radial magnetic flux leakage signal, the distinguishing degree of the defect and the accuracy are improved, also it is easy to implement the method manually or by a computer, thus overcoming disadvantages of the conventional quantization algorithm which evaluates the defect only using the axial magnetic flux leakage signal, improving recognition capability and the quantification accuracy for all kinds of irregular defects and having a broad application prospect.

Any process or method described in the flowing diagram or other means may be understood as a module, segment or portion including one or more executable instruction codes of the procedures configured to achieve a certain logic function or process, and the preferred embodiments of the present disclosure include other performances, in which the performance may be achieved in other orders instead of the order shown or discussed, such as in a almost simultaneous way or in an opposite order, which should be appreciated by those having ordinary skills in the art to which embodiments of the present disclosure belong.

The logic and/or procedures indicated in the flowing diagram or described in other means herein, such as a constant sequence table of the executable code for performing a logical function, may be implemented in any computer readable storage medium so as to be adopted by the code execution system, the device or the equipment (such a system based on the computer, a system including a processor or other systems fetching codes from the code execution system, the device and the equipment, and executing the codes) or to be combined with the code execution system, the device or the equipment to be used. With respect to the description of the present invention, “the computer readable storage medium” may include any device including, storing, communicating, propagating or transmitting program so as to be used by the code execution system, the device and the equipment or to be combined with the code execution system, the device or the equipment to be used. The computer readable medium includes specific examples (a non-exhaustive list): the connecting portion (electronic device) having one or more arrangements of wire, the portable computer disc cartridge (a magnetic device), the random access memory (RAM), the read only memory (ROM), the electrically programmable read only memory (EPROMM or the flash memory), the optical fiber device and the compact disk read only memory (CDROM). In addition, the computer readable storage medium even may be papers or other proper medium printed with program, as the papers or the proper medium may be optically scanned, then edited, interpreted or treated in other ways if necessary to obtain the program electronically which may be stored in the computer memory.

It should be understood that, each part of the present invention may be implemented by the hardware, software, firmware or the combination thereof. In the above embodiments of the present invention, the plurality of procedures or methods may be implemented by the software or hardware stored in the computer memory and executed by the proper code execution system. For example, if the plurality of procedures or methods is to be implemented by the hardware, like in another embodiment of the present invention, any one of the following known technologies or the combination thereof may be used, such as discrete logic circuits having logic gates for implementing various logic functions upon an application of one or more data signals, application specific integrated circuits having appropriate logic gates, programmable gate arrays (PGA), field programmable gate arrays (FPGA).

It can be understood by those having the ordinary skills in the related art that all or part of the steps in the method of the above embodiments can be implemented by instructing related hardware via programs, the program may be stored in a computer readable storage medium, and the program includes one step or combinations of the steps of the method when the program is executed.

In addition, each functional unit in the present disclosure may be integrated in one progressing module, or each functional unit exists as an independent unit, or two or more functional units may be integrated in one module. The integrated module can be embodied in hardware, or software. If the integrated module is embodied in software and sold or used as an independent product, it can be stored in the computer readable storage medium.

The computer readable storage medium may be, but is not limited to, read-only memories, magnetic disks, or optical disks.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A method for quantifying a pipeline defect based on a magnetic flux leakage testing, comprising:
performing a magnetic flux leakage testing on a pipeline to be tested so as to obtain three-dimensional magnetic flux leakage testing data of the pipeline to be tested; and
quantifying a defect on the pipeline to be tested according to the three-dimensional magnetic flux leakage testing data of the pipeline to be tested and a pre-established quantization formula, so as to obtain a size and distribution of the defect;
wherein the three-dimensional magnetic flux leakage testing data comprises: circumferential magnetic flux leakage testing data, axial magnetic flux leakage testing data and radial magnetic flux leakage testing data.

2. The method according to claim 1, wherein the pre-established quantization formula is established by steps of:
performing a magnetic flux leakage testing on a reference pipeline with a same thickness and material as the pipeline to be tested so as to obtain three-dimensional magnetic flux leakage testing data of the reference pipeline, in which standard defects are regularly distributed on the reference pipeline; and
evaluating the standard defects regularly distributed on the reference pipeline according to the three-dimensional magnetic flux leakage testing data of the reference pipeline, so as to obtain the pre-established quantization formula.

3. The method according to claim 2, wherein evaluating the standard defects regularly distributed on the reference pipeline according to the three-dimensional magnetic flux leakage testing data of the reference pipeline comprises:
obtaining a first average value of the three-dimensional magnetic flux leakage testing data of the reference pipeline;
filtering the three-dimensional magnetic flux leakage testing data of the reference pipeline with a first threshold so as to obtain features of a magnetic flux leakage signal of the reference pipeline, in which the first threshold is a preset multiple of the first average value; and
evaluating the standard defects regularly distributed on the reference pipeline according to the features of the magnetic flux leakage signal of the reference pipeline, so as to obtain the pre-established quantization formula.

4. The method according to claim 3, wherein quantifying a defect on the pipeline to be tested according to the three-dimensional magnetic flux leakage testing data of the pipeline to be tested and a pre-established quantization formula comprises:
obtaining a second average value of the three-dimensional magnetic flux leakage testing data of the pipeline to be tested;
filtering the three-dimensional magnetic flux leakage testing data of the pipeline to be tested with a second threshold so as to obtain features of a magnetic flux leakage signal of the pipeline to be tested, in which the second threshold is the preset multiple of the second average value; and
substituting the features of the magnetic flux leakage signal of the pipeline to be tested into the pre-established quantization formula, so as to obtain a size and distribution of the defect.

5. The method according to claim 3, wherein the features of the magnetic flux leakage signal comprise: features of a circumferential magnetic flux leakage signal, features of an axial magnetic flux leakage signal and features of a radial magnetic flux leakage signal;
wherein evaluating the standard defects regularly distributed on the reference pipeline according to the features of the magnetic flux leakage signal of the reference pipeline comprises:
evaluating the standard defects according to features of a circumferential magnetic flux leakage signal of the reference pipeline so as to obtain a width quantification formula;
evaluating the standard defects according to features of a radial magnetic flux leakage signal of the reference pipeline so as to obtain a length quantification formula; and
evaluating the standard defects according to features of an axial magnetic flux leakage signal of the reference pipeline and the features of the radial magnetic flux leakage signal of the reference pipeline so as to obtain a depth quantification formula.

6. The method according to claim 1, wherein a magnetic flux leakage testing is performed on a pipeline by steps of:
saturation magnetizing the pipeline by a direct current magnetic field; and
collecting data at a first equal interval in the pipeline by a three-dimensional sensor array at a preset speed so as to obtain three-dimensional magnetic flux leakage testing data of the pipeline, in which the three-dimensional sensor array comprises a plurality of three-dimensional sensors, and a liftoff value of each three-dimensional sensor is within a preset value range.

7. The method according to claim 5, wherein three groups of standard defects are equally spaced on the reference pipeline in a circumferential direction, standard defects in each group are distributed in a axial direction at a second equal interval.

8. The method according to claim 7, wherein
a first group comprises N variable-length defects, in which a width of each of the N variable-length defects is 2.5 T, a depth of each of the N variable-length defects is 0.25 T, and lengths of the N variable-length defects are in an array of 0.5 T, 1 T, . . . , N×0.5 T;
a second group comprises N variable-width defects, in which a length of each of the N variable-width defects is 2.5 T, a depth of each of the N variable-width defects is 0.25 T, and widths of the N variable-width defects are in the array of 0.5 T, 1 T, . . . , N×0.5 T;
a third group comprises N variable-depth defects, in which a length of each of the N variable-depth defects is 2.5 T, a width of each of the N variable-depth defects is 0.5 T, and depths of the N variable-depth defects are in the array of 0.05 T, 0.1 T, . . . , N×0.05 T,
wherein difference between each two adjacent element in the array is 0.5 T, N is a positive integer, T represents the thickness of the reference pipeline and the second equal interval is within a range of 10 T˜30 T.

9. The method according to claim 5, wherein evaluating the standard defects according to features of a circumferential magnetic flux leakage signal of the reference pipeline so as to obtain a width quantification formula comprises:
measuring a number of influenced channels according to the circumferential magnetic flux leakage signal for a standard defect, and analyzing a relationship between the number of influenced channels and a width of the standard defect, so as to obtain the width quantization formula, wherein the width quantization formula is expressed by a formula of
W=R×π×N₁/N₀,
where W represents the width of the standard defect, R represents an external diameter of the reference pipeline, N₁ represents the number of influenced channels and N₀ represents a number of all channels in the circumferential direction.

10. The method according to claim 5, wherein evaluating the standard defects according to features of a radial magnetic flux leakage signal of the reference pipeline so as to obtain a length quantification formula comprises:
measuring a peak-valley space of the radial magnetic flux leakage signal for a standard defect, analyzing a relationship between the peak-valley space and a length of the standard defect, so as to obtain the length quantization formula based on a linear regression calculation, wherein the length quantization formula is expressed by a formula of
L=a×Sₚ₋ᵥ+b
where L represents the length of the standard defect, Sₚ₋ᵥ represents the peak-valley space indicating a distance from a peak of the radial magnetic flux leakage signal to a valley of the radial magnetic flux leakage signal, a and b are preset coefficients.

11. The method according to claim 5, wherein evaluating the standard defects according to features of an axial magnetic flux leakage signal of the reference pipeline and the features of the radial magnetic flux leakage signal of the reference pipeline so as to obtain a depth quantification formula comprises:
measuring a peak value of the axial magnetic flux leakage signal and a peak-valley value of the radial magnetic flux leakage signal for a standard defect, analyzing a relationship between the peak value, the peak-valley value and a depth of the standard defect, so as to obtain the depth quantization formula based on a multivariate linear fitting and introduced speed factors, wherein the depth quantization formula is expressed by a formula of
$$D = \sqrt{\frac{L}{W}} \times ( \sqrt[3]{e \times {X}_{p}^{2}} \times {σ}_{1} + f \times {Y}_{p - v} \times {σ}_{2} ) - g$$
where D represents the depth of the standard defect, L represents a length of the standard defect, W represents a width of the standard defect, Xₚ represents the peak value, Yₚ₋ᵥ represents the peak-valley value indicating a difference between a peak value of the radial magnetic flux leakage signal and a valley value of the radial magnetic flux leakage signal, σ₁ represents a speed factor of the peak value in the axial direction, σ₂ represents a speed factor of the peak-valley value in the radial direction, σ₁=j+kV, σ₂=m+nV, in which e, f, g, j, k, m, n are preset coefficients.

12. The method according to claim 6, wherein the preset speed is within a range of 0.1˜3.0 m/s, the preset value range is [1.0 mm, 5.0 mm] and the first equal interval is within a range of 0.5˜8.0 mm.

13. The method according to claim 4, wherein the present multiple is within a range of [1.2, 1.5].

14. The method according to claim 5, wherein the features of the circumferential magnetic flux leakage signal comprise a number N₁ of influenced channels, a number N₀ of all channels in the circumferential direction; the features of the radial magnetic flux leakage signal comprise a peak-valley space Sₚ₋ᵥ of the radial magnetic flux leakage signal, and a peak-valley value Yₚ₋ᵥ of the radial magnetic flux leakage signal; and the features of the axial magnetic flux leakage signal comprise a peak value Xₚ of the axial magnetic flux leakage signal.

15. An apparatus for quantifying a pipeline defect based on a magnetic flux leakage testing, comprising:
a processor;
a memory for storing instructions executable by the processor;
wherein the processor is configured to:
perform a magnetic flux leakage testing on a pipeline to be tested so as to obtain three-dimensional magnetic flux leakage testing data of the pipeline to be tested; and
quantify a defect on the pipeline to be tested according to the three-dimensional magnetic flux leakage testing data of the pipeline to be tested and a pre-established quantization formula, so as to obtain a size and distribution of the defect; wherein the three-dimensional magnetic flux leakage testing data comprises: circumferential magnetic flux leakage testing data, axial magnetic flux leakage testing data and radial magnetic flux leakage testing data.

16. A storage medium for storing an application program which is configured to execute the method for quantifying a pipeline defect based on a magnetic flux leakage testing, wherein the method comprises:
performing a magnetic flux leakage testing on a pipeline to be tested so as to obtain three-dimensional magnetic flux leakage testing data of the pipeline to be tested; and
quantifying a defect on the pipeline to be tested according to the three-dimensional magnetic flux leakage testing data of the pipeline to be tested and a pre-established quantization formula, so as to obtain a size and distribution of the defect;
wherein the three-dimensional magnetic flux leakage testing data comprises: circumferential magnetic flux leakage testing data, axial magnetic flux leakage testing data and radial magnetic flux leakage testing data.
